(19) United States
(12) Patent Application Publication
(10) Pub. No.: US 2012/0231304 A1
(43) Pub. Date: Sep. 13, 2012

(54) METHOD AND DEVICE FOR COOLING AN ELECTROCHEMICAL ENERGY STORE

(75) Inventors: Joerg Kaiser, Kamenz (DE); Volker Hennige, Duelmen (DE); Holger Mikus, Kamenz (DE); Tim Schaefer, Niedersachswerfen (DE)

(73) Assignee: LI-TEC BATTERY GMBH, Kamenz (DE)

(21) Appl. No.: 13/390,552

(22) PCT Filed: Aug. 19, 2010
(86) PCT No.: PCT/EP2010/005094

§ 371 Date: May 29, 2012

(30) Foreign Application Priority Data
Aug. 19, 2009 (DE) 10 2009 038 065.5

(51) Int. Cl. H01M 10/50

(52) U.S. Cl. 429/50; 429/72

(57) ABSTRACT

A device for cooling an electrochemical energy store, particularly a galvanic cell containing lithium, is provided with a cooling agent (209) which has an extinguishing effect in the event of a fire and which flows through or around the energy store, the housing thereof (201), or parts of the energy store or of the housing thereof.

Priority application DE 10 2009 038 065.5 is fully incorporated by reference into the present application.

The present invention relates to a method and a device for cooling an electrochemical energy store, particularly a lithium ion storage battery. Electrochemical stores of this kind are used in vehicles, for example. However, the invention may also be used in electrochemical energy stores without lithium and also independently of vehicles.

Different devices and methods for cooling an electrochemical energy store are known in the art.

DE 10 2005 017 648 A1 discloses a liquid-cooled battery with a plurality of storage cells and at least one volume in thermally conductive contact with the storage cells, said volume being capable of having a cooling medium flowing through it. Each of the storage cells in this case exhibits a safety valve, which opens the storage cell when a predefined media pressure is exceeded therein and connects the storage cell volume with the environment. In this case, the safety valves are disposed in the storage cells, such that if one of the safety valves opens, a connection is made between the volume capable of having the cooling medium flowing through it and the inside of the storage cell with the open safety valve.

Further devices and methods for cooling electrochemical energy stores have been disclosed, which cannot be presented exhaustively or in any way representatively here. However these devices and methods may differ, the one thing they all have in common is that they cannot prevent with absolute certainty an electrochemical energy store from overheating and possibly setting on fire as a result of this.

The problem addressed by the present invention is therefore to indicate a device and a method for cooling electrochemical energy stores, which is able to alleviate the consequences of overheating and, in particular, of a fire in the energy store.

This problem is solved by a device and a method according to one of the independent patent claims. The dependent claims are intended to protect advantageous developments.

According to the invention, a device and a method for cooling an electrochemical energy store, particularly a lithium-containing galvanic cell, are provided, in which a coolant having an extinguishing effect in the event of a fire flows around or through the energy store, the housing thereof or parts of the energy store or of the housing thereof.

The problem is further solved through the use of a mixture of a polymer, a surfactant, an ester oil and water or through the use of an additive in the form of a mixture of a polymer, a surfactant and/or an ester oil in conjunction with water as a coolant for cooling an electrochemical energy store, particularly a lithium-containing galvanic cell, wherein the coolant flows around or through the energy store, the housing thereof or parts of the energy store or the housing thereof and has an extinguishing effect in the event of a fire.

In connection with the description of the present invention, an electrochemical energy store should be understood to be any kind of energy store from which electrical energy can be taken, wherein an electrochemical reaction takes place inside the energy store. The term particularly covers all kinds of galvanic cells, especially primary cells, secondary cells and interconnections of such cells to batteries made up of such cells. Electrochemical energy stores of this kind normally exhibit negative and positive electrodes, which are separated by a separator. Ion transportation between the electrodes takes place by means of an electrolyte.

A coolant within the meaning of the present invention should be understood to be a flowable material, particularly a gaseous or liquid thermal transportation medium, which absorbs heat from its environment, transports said heat by flow and is also able to emit said heat into its environment and which has physical properties that make it suitable for transporting heat by heat conduction and/or heat transport by aerodynamic or hydrodynamic flows, particularly also by convection flows, in the heat transport medium. Important examples of heat transport media generally used in technology are, for example, air or water or other customary coolants. Depending on the application context, other gases or liquids are also customary, such as chemically inert (low reactivity) gases or liquids like noble gases or liquefied noble gases, for example, or substances with high thermal capacity and/or thermal conductivity.

Flowable material in this context should be understood to mean any material in which a flow can develop in the aerodynamic or hydrodynamic sense or in which a flow of this kind can be maintained. Examples of such materials are gases and liquids in particular. However, flows within this meaning can also be maintained or can occur in a mixture of liquids or gases and finely distributed solids, so-called aerosols, or in colloidal solutions.

An extinguishing effect in connection with the present invention should be understood to be an effect that counteracts a fire, i.e. is able to prevent the occurrence or mitigate the consequences of a fire.

In this context, a fire is understood to be any process in which the energy store or parts of the energy store or the environment thereof transform or decompose in an unwanted chemical reaction. Fires in this sense are, in particular, exothermic chemical reactions of structural elements or components of an energy store or the environment thereof, which frequently occur as a result of the overheating of the energy store or the components thereof.

In connection with the description of the present invention, a viscoelastic fluid should be understood to be a fluid that exhibits the property of viscoelasticity. An (ideal) fluid is understood to be a substance that puts up (more or less) no resistance to an arbitrarily slow shear strain. A distinction is made between compressible fluids (gases) and incompressible fluids (liquids). The generic term “fluid” is used because most physical laws for gases and liquids apply (more or less) equally and many of their properties differ from one another only quantitatively, but not in principle qualitatively. Real fluids may be subdivided depending on their behaviour into “Newtonian fluids” with the flow mechanics describing them and “non-Newtonian fluids” with the rheology describing them. The difference in this case lies in the flow properties of the medium, which is described by the functional relationship between shear stress and distortion velocity or shear velocity.

Viscoelasticity is used to denote the time-, temperature- and/or frequency-dependent elasticity of fluids, such as polymer melts or solids like plastics, for example. Viscoelasticity is characterised by partially elastic, partially viscous behaviour. Following the removal of an external force, the material returns only incompletely to its initial state; the remaining energy is extracted in the form of flow processes.

In connection with the description of the present invention, a gel should be understood to be a finely dispersed system comprising at least a first, frequently solid, and at least a second, frequently liquid, phase. A gel frequently represents a colloid. The solid phase in this case forms a spongy, three-dimensional network, the pores of which are filled by a liquid or by a gas. In this case, the two phases frequently penetrate one another completely. Colloids denote particles or droplets, which are finely distributed in another medium (solid, gas or liquid), the dispersion medium.

Advantageous developments of the invention are the subject-matter of dependent claims.

In a preferred device according to the invention, the coolant flows through a coolant circuit which is closed when the energy store is operating normally and which is designed such that the coolant emerges from the closed coolant circuit at given points in the event of a fire and is able to have an extinguishing effect at said points. In this way, the extinguishing effect can be deployed at particular points affected by a fire; at the same time, the coolant affect can be retained.

A particularly preferred device according to the invention exhibits a mechanism for stabilising the coolant pressure when the coolant emerges at given points from the coolant circuit in the event of a fire. This embodiment of the invention may be associated with the coolant pressure and therefore the cooling effect being largely or completely maintained when the coolant emerges at certain points from the cooling system, in order to deploy its extinguishing effect at said points.

In a further preferred device according to the invention, the coolant is a gel or a viscoelastic fluid. Gels are frequently associated with an improved cooling effect compared with fluids. The evaporation rate of the fluid components of a gel is frequently lower than that of the fluid. The retention time and active time of the liquid component is frequently improved as a result. At the same time, a gel may guarantee effective air exclusion at the seat of the fire.

In a further preferred device according to the invention, the coolant is a colloidal, viscoelastic fluid.

In a further preferred device according to the invention, the coolant contains water. Water is a readily available and in many cases extremely effective coolant and extinguishing agent. Its suitability is possibly limited by the choice of a specific technology for the galvanic cell of an electrochemical energy store.

In a further preferred device according to the invention, the coolant is made up of a mixture of water and a polymer, a surfactant and/or an ester oil.

In a further preferred device according to the invention, the coolant comprises a mixture of at least one polymer, at least one surfactant, at least one ester oil and water.

In a particularly preferred device according to the invention, the coolant is made up of a mixture of P % by weight of at least one polymer, T % by weight of at least one surfactant, E % by weight of at least one ester oil and W % by weight water, relative to the total amount of coolant, in which

10≦P≦35,

1≦T≦10,

10≦E≦35,

20≦W≦55

and

P+T+E+W=100.

In a particularly preferred device according to the invention, the coolant is made up of a mixture of P % by weight of at least one polymer, T % by weight of at least one surfactant, E % by weight of at least one ester oil and W % by weight water, relative to the total amount of coolant, in which

25≦P≦31,

4≦T≦8,

18≦E≦28,

38≦W≦48

and

P+T+E+W=100.

In a particularly preferred device according to the invention, the coolant is made up of a mixture of approx. 28% of at least one polymer, approx. 6% of at least one surfactant, approx. 23% of at least one ester oil and approx. 43% water.

In a further preferred device according to the invention, the coolant is characterised by a dynamic viscosity of between 100 and 1000 mPas.

In a further preferred device according to the invention, a coolant is used which flows through a coolant circuit that is closed when the energy store is operating normally, which is designed such that the coolant is able to escape from the closed coolant circuit at certain points and is mixed with an additive when it emerges from the coolant circuit, wherein a gel or a viscoelastic fluid is formed.

In a further preferred device according to the invention, water is used as a coolant, which flows through a coolant circuit that is closed when the energy store is operating normally, said coolant circuit being designed such that the water is able to emerge from the closed coolant circuit at given points in the event of a fire and is mixed with an additive when it emerges from the coolant circuit, wherein a gel or a viscoelastic fluid is formed.

In a particularly preferred device according to the invention, the additive comprises a mixture of at least one polymer, at least one surfactant and at least one ester oil.

In a particularly preferred device according to the invention, the additive comprises a mixture of P % by weight of at least one polymer, T % by weight of at least one surfactant and E % by weight of at least one ester oil, relative to the total amount of additive, wherein

12≦P≦78,

1≦T≦22,

12≦E≦78,

and

P+T+E=100.

In the case of a particularly preferred device according to the invention, the additive comprises a mixture of P % by weight of a polymer, T % by weight of at least one surfactant and E % by weight of at least one ester oil, relative to the total amount of additive, wherein

45≦P≦55,

8≦T≦12,

35≦E≦45,

and

P+T+E=100.

In the case of a particularly preferred device according to the invention, the additive comprises a mixture of approx. 50% of at least one polymer, approx. 10% by weight of at least one surfactant and approx. 40% by weight of at least one ester oil.

Particularly preferred in addition is the use of a mixture of P % by weight of at least one polymer, T % by weight of at least one surfactant, E % by weight of at least one ester oil and W % by weight water, relative to the total amount of coolant, wherein

10≦P≦35,

1≦T≦10,

10≦E≦35,

20≦W≦55

and

P+T+E+W=100.

Particularly preferred in addition is the use of a mixture of P % by weight of at least one polymer, T % by weight of at least one surfactant, E % by weight of at least one ester oil and W % by weight water, relative to the total amount of coolant, wherein

25≦P≦31,

4≦T≦8,

18≦E≦28,

38≦W≦48

and

P+T+E+W=100.

Particularly preferred in addition is the use of a mixture of approx. 28% of at least one polymer, approx. 6% of at least one surfactant, approx. 23% of at least one ester oil and approx. 43% water as a coolant for cooling an electrochemical energy store, particularly a lithium-containing galvanic cell, wherein the coolant flows around or through the energy store, the housing thereof or parts of the energy store or the housing thereof and deploys its extinguishing effect in the event of a fire.

Particularly preferred in addition is the use of an additive in the form of a mixture comprising a polymer, a surfactant and/or an ester oil in conjunction with water as a coolant for cooling an electrochemical energy store, particularly a lithium-containing galvanic cell, wherein the coolant flows around or through the energy store, the housing thereof or parts of the energy cell or the housing thereof and has an extinguishing effect in the event of a fire in conjunction with the additive.

Particularly preferred in addition is the use of an additive in the form of a mixture comprising a P % by weight of at least one polymer, T % by weight of at least one surfactant and E % by weight of at least one ester oil, relative to the total amount of additive, wherein

12≦P≦78,

1≦T≦22,

12≦E≦78,

and

P+T+E=100.

Particularly preferred in addition is the use of an additive in the form of a mixture comprising P % by weight of at least one polymer, T % by weight of at least one surfactant and E % by weight of at least one ester oil, relative to the total amount of additive, wherein

45≦P≦55,

8≦T≦12,

35≦E≦45,

and

P+T+E=100.

Particularly preferred in addition is the use of an additive comprising a mixture of approx. 50% of at least one polymer, approx. 10% of at least one surfactant and approx. 40% of at least one ester oil in conjunction with water as a coolant for cooling an electrochemical energy store, particularly a lithium-containing galvanic cell, wherein the coolant flows around or through the energy store, the housing thereof or parts of the energy store or the housing thereof and has an extinguishing effect in the event of a fire in conjunction with the additive.

The invention is described in greater detail below with the help of the figures using preferred exemplary embodiments. In these

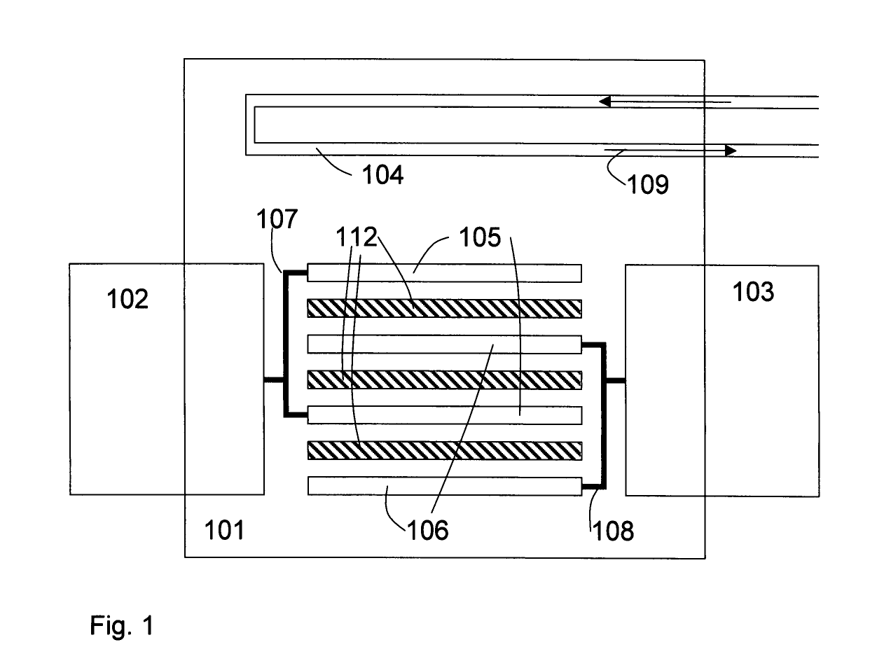

FIG. 1 shows schematically a representation of a device according to the invention for cooling an electrochemical energy store in accordance with a first exemplary embodiment of the invention;

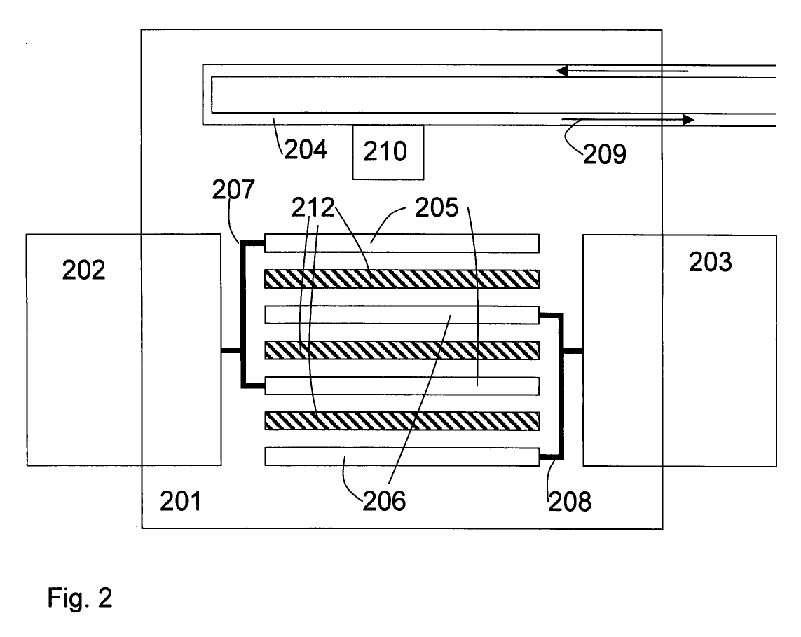

FIG. 2 shows schematically a representation of the cooling according to the invention of an electrochemical energy store in accordance with a second exemplary embodiment of the invention;

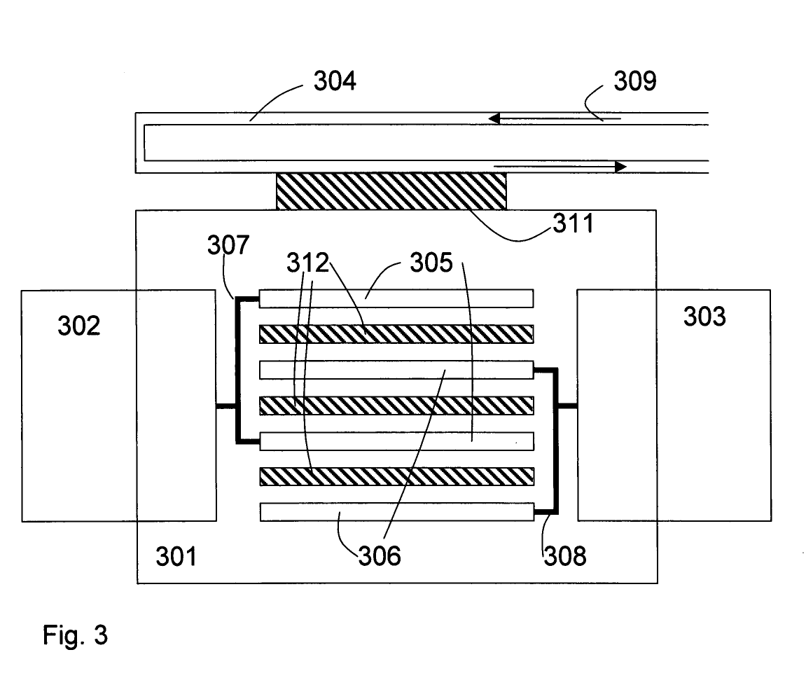

FIG. 3 shows schematically a representation of the cooling according to the invention of an electrochemical energy store in accordance with a second exemplary embodiment of the invention; and

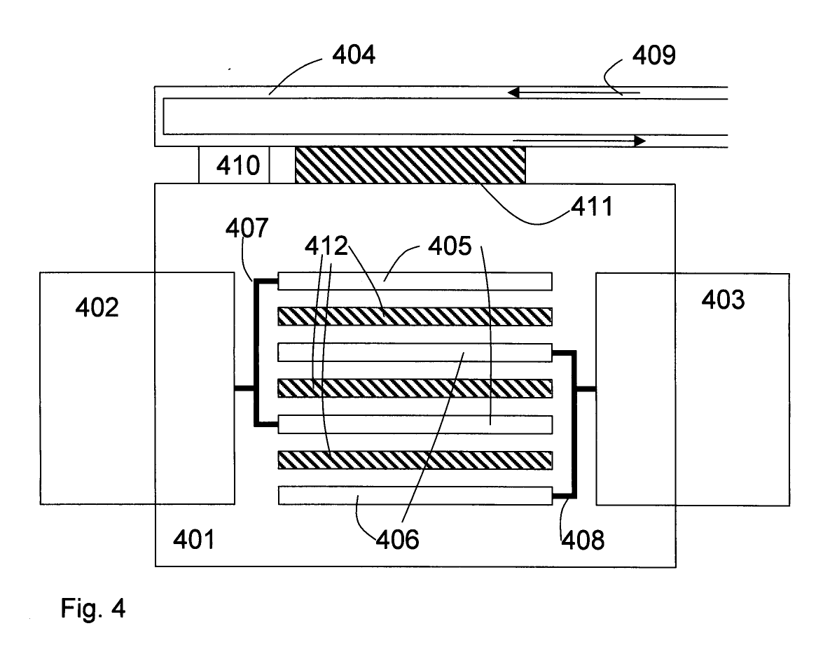

FIG. 4 shows schematically a representation of the cooling according to the invention of an electrochemical energy store in accordance with a second exemplary embodiment of the invention.

As shown schematically in FIGS. 1 to 4, an electrochemical energy store according to the invention exhibits a housing 101, 201, 301, 401, in which various components of the electrochemical energy store are located. These components comprise a configuration of electrodes 105, 106 which are separated from one another by a configuration of separators and between which is located an ion-conductive electrolyte. In this case, the active materials may be differently disposed within the electrochemical energy store, in other words, in the galvanic cell.

Typical configurations of this kind are so-called electrode windings or electrode stacks. The invention is not limited to a particular configuration of electrodes and further active materials in the galvanic cell. As shown schematically in FIGS. 1 to 4, the electrodes 105, 106 are frequently connected via so-called inner connectors 107, 207, 307, 407 and 108, 208, 308, 408 to so-called outer current connectors 102, 202, 302, 402 and 102, 203, 303, 403. In this case, the positive electrodes 105, 205, 305, 405 are connected to the positive connector 102, 202, 302, 402 and the negative electrodes 106, 206, 306, 406 to the negative connector 103, 203, 303, 403. Separators 112, 212, 312, 412 are usually disposed between opposite electrodes, which prevent an inner short-circuit in the galvanic cell.

During the charging or discharging process in a galvanic cell, chemical reactions occur in said cell, which are associated with frequently substantial heat generation. Depending on the design of the electrochemical energy store, cooling may therefore be needed to prevent this heat generation from leading to an unwanted or unacceptable temperature rise. As shown schematically in FIGS. 1 to 4, the invention provides for a coolant 109, 209, 309, 409 flowing around or through the energy store, the housing thereof 101, 201, 301, 401 or parts of the energy store or the housing thereof. It is further provided according to the invention that this coolant has an extinguishing effect in the event of a fire.

The basic idea underlying this invention can be executed in a variety of ways. A first exemplary embodiment of the invention is schematically represented in FIG. 1. In this exemplary embodiment the coolant 109 flows through special flow channels 104, which are preferably designed so that although the coolant is in very good thermal contact with the inside of the electrochemical energy store, at the same time, however, a direct contact facilitating chemical reactions between the coolant and the inside of the energy store is avoided during normal operation. So that the coolant is able to have an extinguishing effect in the event of a fire, the flow channels 104 are preferably designed such that the coolant is able to emerge from the flow channels in the event of a fire and can thereby have an extinguishing effect within the electrochemical energy store. This may take place, for instance, in that the flow channels are designed in such a way that they are destroyed locally or at least opened by a fire, so that the coolant 109 is able to emerge from the flow channels 104.

As shown schematically in FIG. 2, a second exemplary embodiment of the invention provides that the emergence of the coolant 209 from the flow channel 204 is effected by a special mechanism 210, which selectively opens the flow channel 204 in the event of a fire, so that coolant can escape into the inside of the electrochemical energy store. Preferred examples of such mechanisms 210 are blow-out discs, for example, preferably thermally controlled valves or also electrically controlled valves, for example, which can be connected to preferably suitable temperature sensors and preferably to suitable control logic.

FIG. 3 shows a third exemplary embodiment of the invention in schematic form, in which the flow channels 304 through which the coolant 309 flows are disposed outside the housing 301 of the electrochemical energy store, and in which a thermal conduction mechanism 311 ensures that there is a sufficiently good thermal conduction contact between the flow channel 304 and the housing 301 of the energy store. The fourth exemplary embodiment of the present invention schematically represented in FIG. 4 differs from the third exemplary embodiment principally in that a mechanism 410 is provided in this case, similar to the one in FIG. 2, which is intended to effect a controlled emergence of coolant from the flow channel in the event of a fire.

The thermal conduction mechanism 311, 411 is preferably a metallic body having in any case good thermal conductivity, the shape of which is preferably adapted to the shape of the flow channels and/or to the shape of the housing, such that the best possible thermal conduction is achieved between the coolant and the housing.

The present invention may be realised in various ways. What these exemplary embodiments have in common is that a coolant flows around or through an electrochemical energy store, the housing thereof or parts of the energy store or the housing thereof and that said coolant has an extinguishing effect in the event of a fire. In this case the coolant preferably flows through a coolant circuit that is closed when the energy store is operating normally, as shown schematically in FIGS. 1 to 4. This coolant circuit, which preferably comprises flow channels, is preferably designed such

that the coolant is able to escape from the closed-cycle cooling system at specific points in the event of a fire and can have an extinguishing effect at these points.

A further preferred embodiment of the invention, which may also be combined with other embodiments of the invention, provides that the coolant pressure is stabilised by a mechanism when the coolant emerges at points from the cooling circuit in the event of a fire. Mechanisms of this kind may in turn be realised in different ways. A preferred option involves the coolant pressure being controlled by a pumping mechanism, so that said pressure can be held constant or at least kept at a level which guarantees the continued operation of the coolant circuit when coolant escapes at certain points. However, a mechanism of this kind may also comprise a valve control system which ensures that the coolant emerges from the cooling circuit at certain points only at restricted times and/or only in a limited quantity, so that the coolant pressure loss is either limited or can be rapidly balanced by a subsequent coolant supply from a storage facility.

It is preferable in accordance with the present invention to provide for the use of a gel or a viscoelastic fluid as the coolant. Such gels or viscoelastic fluids may also easily be produced by admixing a corresponding additive, a gel concentrate for example, to water. Experience has shown that gels of this kind bring fires under control more quickly, because water is turned into a flame-resistant, heat-absorbent gel by suitable additives or gel concentrates, said gel also adhering well to smooth surfaces, so that the water bound in the gel is able to deploy its extinguishing effect more effectively, because it does not run away unused. By using a water-based gel rather than pure water, the same extinguishing effect can therefore be achieved with less water and therefore with less coolant, which means that the coolant pressure in the closed-cycle cooling systems is easier to maintain. This is particularly advantageous, because it is thereby possible to avoid excessively reducing the cooling effect of the coolant due to a loss of coolant pressure in the event of a fire.

In addition to gels or viscoelastic fluids, colloidal or colloidal viscoelastic fluids are particularly preferred as coolants. Particularly preferred in this case are coolants that contain water. Furthermore, particularly preferred is a coolant comprising a mixture of at least one polymer, at least one surfactant, at least one ester oil and water. Particularly preferred in this case is a coolant comprising a mixture of approx. 28% of at least one polymer, approx. 6% of at least one surfactant, approx. 23% of at least one ester oil and approx. 43% water.

Coolants with this composition preferably exhibit super-absorbent polymers in their structure, which are slightly swollen with water. Through the addition of ester oil, the polymers are prevented from absorbing more water. By introducing this kind of mixture into suitable quantities of water, the water-in-oil emulsion becomes an oil-in-water emulsion; a so-called phase-reversal therefore takes place. The residual absorption capacity of the super-absorbent polymers that is thereby released binds the remaining water.

This process can be noticeably accelerated through the supply of kinetic energy, by agitation, pumping or mixing in a water flow, for example. The desired viscosity level can thereby by quickly adjusted at an outlet opening in a coolant flow channel, so that the gel is immediately available upon emerging.

Further preferred are coolants with a dynamic viscosity between 100 and 1000 mPas. A higher viscosity in this case generally promotes the coolant's extinguishing effect, but on the other hand makes it more difficult for the coolant to flow through the flow channels. Exemplary embodiments of the invention in which the viscosity of the coolant is kept low before it leaves the flow channels and in which the viscosity of the coolant is increased as quickly as possible when it leaves the flow channels are therefore preferred. This may be achieved, for example, if water or another low-viscosity fluid is used as the coolant in the flow channels, an additive being admixed thereto when it leaves the flow channels in the event of a fire, said additive increasing the viscosity with minimal delay, in other words, as quickly as possible.

An exemplary embodiment of the invention in which water is used as the coolant and in which said coolant flows through a cooling circuit that is closed when the energy store is operating normally is therefore preferred, said system being designed such that the water is able to emerge from the closed-cycle cooling system at certain points in the event of a fire, an additive being mixed into the water when it leaves the cooling system, so that a gel or viscoelastic fluid is thereby formed.

The use of an additive comprising a mixture of at least one polymer, at least one surfactant and at least one ester oil is particularly preferred in this case.

Particularly preferred in addition is an additive comprising a mixture of approx. 50% of at least one polymer, approx. 10% of at least one surfactant and approx. 40% of at least one ester oil.

When assessing the mixture ratios, it is preferable to take into account that the advantageous effects of the cooling and extinguishing mixture or of the additive are based on the viscoelasticity of the cooling and extinguishing mixture and on its ability to bind water. The adhesive force of the coolant on smooth surfaces too can thereby also be increased. The fluid does not flow away unused.

Particularly with mixtures of polymers, ester oils, surfactants and water, a suitable assessment of the mixing ratios under the influence of kinetic energy leads to a significant reduction in viscosity compared with the resting stage. In this way, a low-viscosity mixture of this kind may flow through a cooling circuit and also at the same time exhibit a high viscosity when emerging from this cooling circuit at a fire site. The fluidity of such mixtures therefore depends primarily on the flow velocity.

Through the chemical-physical inclusion of the fluid in a gel structure, the fluid's evaporation rate can be significantly reduced at higher temperatures too. In this way, the fluid consumption can be significantly reduced.

At the fire site, the fluid incorporated in a gel structure may have a greater cooling effect due to the comparatively high layer thickness and the reduced evaporation speed. This effect is particularly important when fighting fires at very high temperatures.

1.-20. (canceled)

21. A device for cooling an electromechanical energy store, particularly a lithium-containing galvanic cell, wherein
a coolant (109, 209, 309, 409) flows around or through the energy store, the housing thereof (101, 201, 301, 401) or parts of the energy store or of the housing thereof, which has an extinguishing effect in the event of a fire
wherein
a) the coolant is a gel or a viscoelastic fluid and flows through a coolant circuit (104, 204, 304, 404) which is closed when the energy store is operating normally and which is designed such that the coolant emerges from the closed coolant circuit at given points in the event of a fire and is able to have an extinguishing effect at said points.
or
b) the coolant flows through a coolant circuit which is closed when the energy store is operating normally and which is designed such that the coolant is able to escape from the closed coolant circuit at certain points in the event of a fire and is mixed with an additive when it emerges from the coolant circuit, wherein a gel or a viscoelastic fluid is formed.

22. The device according to claim 21, comprising a device for stabilizing the coolant pressure when the coolant emerges at given points from the coolant circuit in the event of a fire.

23. The device according to claim 22, comprising a coolant which contains water.

24. The device according to claim 23, comprising a coolant comprising a mixture of at least one polymer, at least one surfactant, at least one ester oil and water.

25. The device according to claim 24, comprising a coolant comprising a mixture of P % by weight of at least one polymer, T % by weight of at least one surfactant, E % by weight of at least one ester oil and W % by weight water, relative to the total amount of coolant, in which
10≦P≦35,
1≦T≦10,
10≦E≦35,
20≦W≦55
and
P+T+E+W=100.

26. The device according to claim 24, comprising a coolant comprising a mixture of
approx. 28% of at least one polymer,
approx. 6% of at least one surfactant,
approx. 23% of at least one ester oil and
approx. 43% water.

27. The device according to claim 26, comprising a coolant having a dynamic viscosity of between 100 and 1000 mPas.

28. The device according to claim 27, comprising water as the coolant and an additive comprising a mixture of at least one polymer, at least one surfactant and at least one ester oil.

29. The device according to claim 28, comprising an additive comprising a mixture of P % by weight of at least one polymer, T % by weight of at least one surfactant and E % by weight of at least one ester oil, relative to the total amount of additive, wherein
12≦P≦78,
1≦T≦22,
12≦E≦78,
and
P+T+E=100.

30. The device according to claim 28, comprising an additive comprising a mixture of
approx. 50% of at least one polymer,
approx. 10% of at least one surfactant and
approx. 40% of at least one ester oil.

31. A method for cooling an electrochemical energy store selected from a lithium-containing galvanic cell, wherein
a coolant a coolant flows around or through the energy store, the housing thereof or parts of the energy store or of the housing thereof, which has an extinguishing effect in the event of a fire
wherein
a) the coolant is a gel or a viscoelastic fluid and flows through a coolant circuit (104, 204, 304, 404) which is closed when the energy store is operating normally and which is designed such that the coolant emerges from the closed coolant circuit at given points in the event of a fire and is able to have an extinguishing effect at said points.
or
b) the coolant flows through a coolant circuit which is closed when the energy store is operating normally and which is designed such that the coolant is able to escape from the closed coolant circuit at certain points in the event of a fire and is mixed with an additive when it emerges from the coolant circuit, wherein a gel or a viscoelastic fluid is formed.

32. A method of cooling an electromechanical energy store, a lithium-containing galvanic cell, comprising circulating a coolant comprising a mixture of at least one polymer, at least one surfactant and at least one ester oil and water, wherein the coolant flows around or through the energy store, the housing thereof or parts of the energy store or of the housing thereof and has an extinguishing effect in the event of a fire.

33. The method according to claim 32, wherein the mixture comprises P % by weight of at least one polymer, T % by weight of at least one surfactant, E % by weight of at least one ester oil and W % by weight water, relative to the total amount of coolant, in which
10≦P≦35,
1≦T≦10,
10≦E≦35,
20≦W≦55
and
P+T+E+W=100.

34. The method according to claim 32, wherein the mixture comprises
approx. 28% of at least one polymer,
approx. 6% of at least one surfactant,
approx. 23% of at least one ester oil and
approx. 43% water.

35. A method for cooling an electrochemical energy store, a lithium-containing galvanic cell, comprising circulating a coolant comprising an additive in the form of a mixture of at least one polymer, at least one surfactant and at least one ester oil in conjunction with water,
wherein
the coolant flows around or through the energy store, the housing thereof or parts of the energy store or the housing thereof and has an extinguishing effect in the event of a fire in conjunction with the additive.

36. The method of an additive according to claim 35, wherein the mixture comprises P % by weight of at least one polymer, T % by weight of at least one surfactant and E % by weight of at least one ester oil, relative to the total amount of additive, wherein
12≦P≦78,
1≦T≦22,
12≦E≦78,
and
P+T+E+W=100.

37. The method of an additive according to claim 35, wherein the mixture comprises
approx. 50% of at least one polymer,
approx. 10% of at least one surfactant and
approx. 40% of at least one ester oil.
